(19) United States
(12) Patent Application Publication
(10) Pub. No.: US 2010/0153126 A1
(43) Pub. Date: Jun. 17, 2010

(54) METHOD AND SYSTEM FOR VERIFYING AN OPERATION IN A BODY OF WATER

(75) Inventor: Jack Duane Garrett, Grapevine, TX (US)

Correspondence Address: OSHA LIANG L.L.P., TWO HOUSTON CENTER, 909 FANNIN, SUITE 3500, HOUSTON, TX, 77010, US

(73) Assignee: GULFSAFE LLC, Dallas, TX (US)

(21) Appl. No.: 12/337,434

(22) Filed: Dec. 17, 2008

(51) Int. Cl. G06Q 10/00

(52) U.S. Cl. 705/1.1

(57) ABSTRACT

A method for verifying an operation in a body of water. The method includes receiving a verification request comprising an operation location for an operation. The method further includes determining at least one of a plurality of mapped grid locations corresponding with the operation location, where the plurality of grids are defined by a Minerals Management Service. The method further includes determining, using an asset repository, an asset associated with at least one of the plurality of mapped grid locations. The method further includes determining an asset holder for the asset. The method further includes sending, to the asset holder, a notification comprising the identity of the operator. The method further includes sending, to the operator as a verification response, the identity of the asset holder.

### BACKGROUND

Onshore industrial operations can effectively be categorized into three categories: where operations require activity entirely on the surface of the land; where operations require activity at a sub-surface depth; and where operations require some combination of the first two categories. In the case of those operations, where excavation at some sub-surface depth is contemplated, there is a measure of uncertainty due in part to obscured visibility extending beyond a plane of excavation that has yet to be broken. With the lack of visibility, a host of underground assets, ranging from sewage and water lines to oil and gas pipelines, lie potentially concealed and are therefore at-risk when the operation is performed. To avoid jeopardizing the in-place assets of another in addition to placing the success of the contemplated operation in jeopardy, operators embrace a “call before you dig” mantra to apprise themselves of at-risk assets in the vicinity of the contemplated operation.

Industrial operations performed offshore introduce additional complications due to an even greater lack of visibility. While the onshore context involves a single visibility-obscuring surface, an ocean surface and an ocean bed both act in a similar visibility-obscuring capacity. As such, the depth range potentially concealed in an offshore context begins at an ocean surface, extends downward to an ocean bed, and extends further downward beneath the ocean bed. This is a significant problem as sub-ocean surface infrastructure can potentially exist, and is therefore potentially concealed, at positions falling anywhere along the range of those concealed depths.

### SUMMARY

In general, in one aspect, the invention relates to a computer readable medium comprising executable instructions for the verification of an operation in a body of water, wherein executable instructions comprise instructions to: receive a verification request comprising an operation location for an operation; determine at least one of a plurality of mapped grid locations corresponding with the operation location; determine, using an asset repository, an asset associated with at least one of the plurality of mapped grid locations; determine an asset holder for the asset; send, to the asset holder, a notification comprising the identity of the operator; and send, to the operator as a verification response, the identity of the asset holder, wherein the plurality of grids are defined by a Minerals Management Service.

In general, in on aspect, the invention relates to a computer readable medium comprising executable instructions for the verification of an operation in a body of water, wherein executable instructions comprise instructions to: receive a verification request comprising an operation location and an operation depth for an operation; determine at least one of a plurality of mapped grid locations corresponding with the operation location; determine, using an asset repository, an asset associated with at least one of the plurality of mapped grid locations, wherein the asset depth of the asset is within a defined range of the operation depth; determine an asset holder for the asset; send, to the asset holder, a notification comprising the identity of the operator; and send, to the operator as a verification response, the identity of the asset holder, wherein the plurality of grids are defined by a Minerals Management Service.

Other aspects of the invention will be apparent from the following description and the appended claims.

### BRIEF DESCRIPTION OF DRAWINGS

FIG. 1a shows a two-dimensional view of assets residing in a body of water as mapped by one or more embodiments of the invention.

FIG. 1b shows a three-dimensional view of the assets shown in FIG. 1a.

FIG. 2 shows a system in accordance with one or more embodiments of the invention.

FIG. 3 shows data maintained in accordance with one or more embodiments of the invention.

FIGS. 4 and 5 show flowcharts in accordance with one or more embodiments of the invention.

FIGS. 6a and 6b shows two-dimensional views of assets residing in a body of water as mapped by one or more embodiments of the invention.

FIG. 7 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for verifying an operation in a body of water. Further, embodiments of the invention are directed to determining an asset that resides in proximity to a contemplated operation. Embodiments of the invention are further directed to providing distinct notification functions for the operator and an asset holder associated with the proximately-located asset.

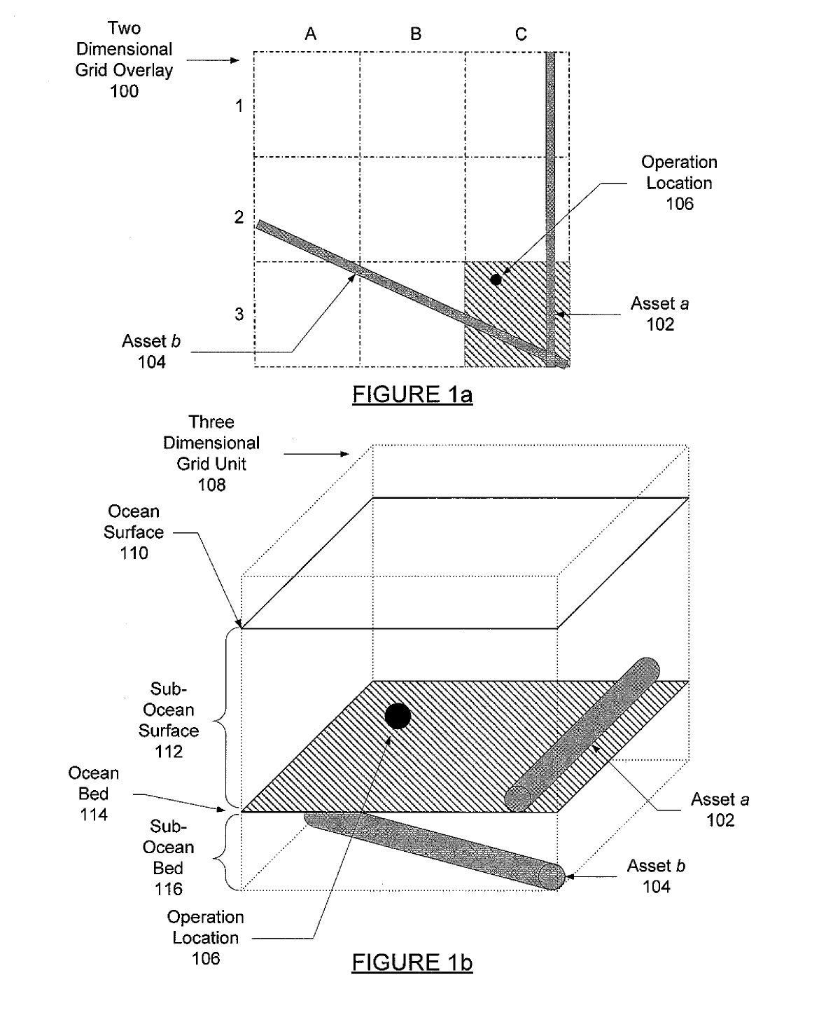

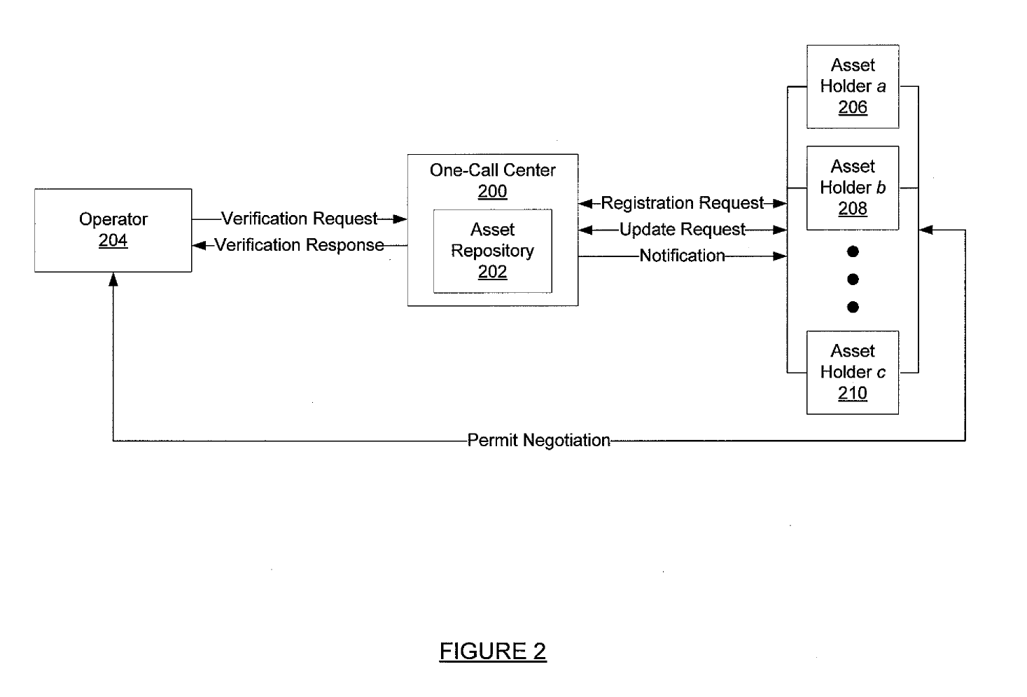

FIG. 1a shows a two-dimensional view of assets residing in a body of water as mapped by one or more embodiments of the invention. In particular, Assets a (102) and Assets b (104) are shown two-dimensionally in relation to a location for a contemplated operation (106). In one embodiment of the invention, the location for the contemplated operation (106) may be in State, Federal, International water jurisdictions, or any combination thereof.

In one or more embodiments of the invention, an offshore asset (102, 104) is mapped against a two-dimensional grid system such that for any one asset (102, 104) there are one or more mapped grid locations with which the asset is associated. As such, the asset is associated with one (or more) mapped grid location in an asset repository. By associating offshore assets (102, 104) with mapped grid locations, a determination may be made about whether any, and if any which, assets are located in a particular mapped grid location. Table 1, below, provides the associations of assets shown in FIG. 1a to mapped grid locations.

TABLE 1
Assets Associated by Grid Location as shown in FIG. 1a

| Grid Locations | Associated Assets |
|---|---|
| Row 1 Column A | None |
| Row 1 Column B | None |
| Row 1 Column C | Asset a |
| Row 2 Column A | Asset b |
| Row 2 Column B | None |
| Row 2 Column C | Asset a |
| Row 3 Column A | Asset b |
| Row 3 Column B | Asset b |
| Row 3 Column C | Asset a, Asset b |

In one embodiment of the invention, a mapped grid location may be determined as a function of a contemplated operation location (106). More specifically, in one or more embodiments of the invention, a mapped grid location is determined for an operation location if the operation location is, at least partially, located in the mapped grid location. For example, returning to FIG. 1a, the mapped grid location for row 3 column C is determined for the contemplated operation location (106).

As such, in one or more embodiments of the invention, the mapped grid location determined in correspondence with a contemplated operation location (106) may be used to determine which, if any, assets are located in the determined grid location. In this example, returning to FIG. 1a, the contemplated operation location (106) falls within the mapped grid location for row 3 column C. The mapped grid location for row 3 column C is associated with Asset a (102) and Asset b (104). Accordingly, the operator, using one or more embodiments of the invention, verifies the contemplated operation location (106) against Asset a (102) and Asset b (104).

In one or more embodiments of the invention, the grid system used for mapping assets and operations is a specific grid system. For example, in one or more embodiments of the invention, the United States Department of the Interior Minerals Management Service (MMS) grid system is used to map assets and operation locations for the purpose of verifying an operation in a body of water. Those skilled in the art will appreciate that other grid systems may be used.

FIG. 1b shows a three-dimensional view of the assets shown in FIG. 1a. In particular, FIG. 1b shows the mapped grid location of row 3 column C from FIG. 1a in three dimensions (108). Specifically, FIG. 1b introduces a depth dimension that shows Asset a (102), Asset b (104), the contemplated operation location (106), an ocean surface (110), the sub-ocean surface (112), the ocean bed (114), and the sub-ocean bed (116) in relation to one another.

In view of the more pronounced visibility issues, one or more embodiments of the invention associate a depth measurement with each asset. This consideration is significant in instances where an operation depth and an asset depth vary at a given location to such an extent that neither the operation nor the asset will be jeopardized. In other instances, the disparity between an operation depth and the asset depth at a given location may be too slight to permit the operation to proceed at the location. In one or more embodiments of the invention, a range is specified for use in deciding whether an operation depth is too close to the asset depth of a registered asset.

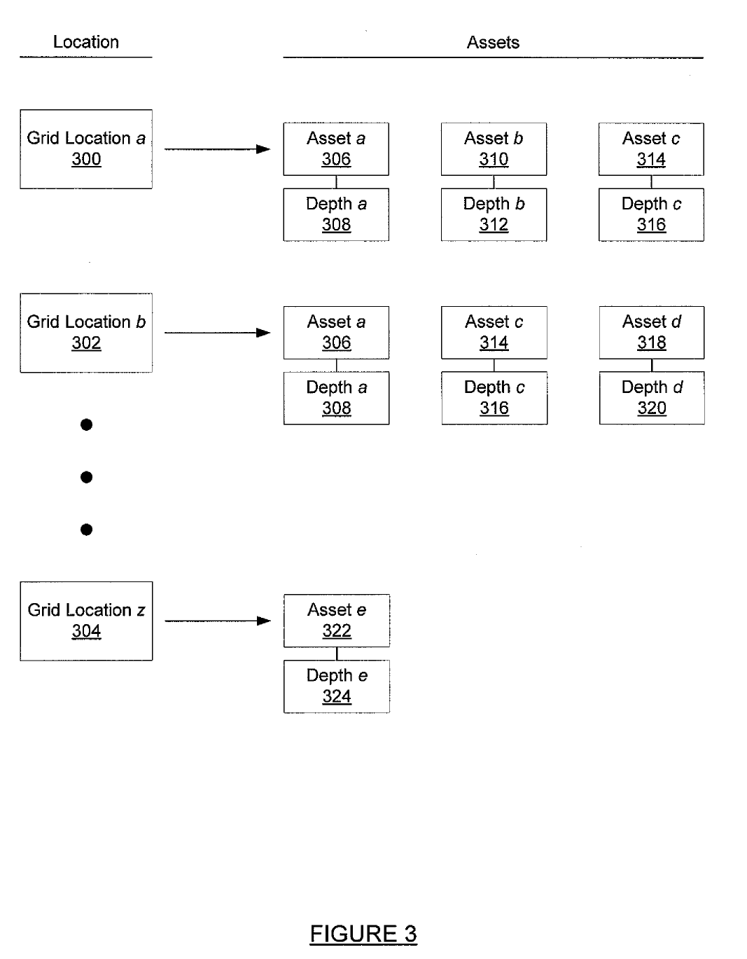

FIG. 2 shows a system in accordance with one or more embodiments of the invention. As shown in FIG. 2, the one-call center (200) is configured to receive a registration request for an asset from one or more asset holders (206, 208, 210). In one or more embodiments of the invention, the registration request includes an asset location for the asset. Upon the processing of the registration request, the one-call center (200) associates the asset with one or more mapped grid locations. In one or more embodiments of the invention, the one-call center (200) is configured to solicit registration from an asset holder (206, 208, 210) for an unregistered asset.

In one or more embodiments of the invention, the one-call center (200) is also configured to receive an update request from the one or more asset holders (206, 208, 210). In one or more further embodiments of the invention, the asset holder (206, 208, 210) sends the one-call center (200) the update request in the event that a registered asset has had an effective change in location. Upon processing of the update request, the one-call center (200) associates the asset with one or more mapped grid locations corresponding with the new location (or buffer zone (described below)) for the asset. In one or more embodiments of the invention, the one-call center (200) is configured to solicit an update from an asset holder (206, 208, 210) for a registered asset.

In one or more embodiments of the invention, the one-call center (200) includes an asset repository (202) configured to store and maintain an association between a mapped grid location and the registered assets that are located therein. As such, associations determined and updated through the processing of registration and updated requests respectively are stored and maintained by the asset repository (202). In one or more embodiments of the invention, the one-call center (200) maintains asset registrations that span across one or more state water jurisdictions. In one or more further embodiments of the invention, asset registrations stored and maintained by the one-call center may include assets located in federal and/or international water jurisdictions.

In one embodiment of the invention, the asset repository (202) may be configured to maintain additional information about the various grid locations. For example, the asset repository (202) may maintain, for each grid location, (i) whether the grid location (or portion thereof) is located in a restricted area (e.g., Naval testing site, etc.) as designated by a State or Federal Government (or any agency thereof) and (ii) whether the grid location (or portion thereof) is located in a protected area (e.g., protected coral reef, etc.) as designated by a State or Federal Government (or any agency thereof).

In one embodiment of the invention, the asset repository (202) may be implemented using any storage device configured to persistently store data. Examples of such storage devices may include, but are not limited to, a hard disk, a optical disk, a solid-state device (e.g., a NAND Flash or NOR Flash drive), or any combination thereof.

As shown in FIG. 2, the one-call center (200) is also configured to receive a verification request from an operator (204). In one or more embodiments of the invention, the verification request includes an operation location for a contemplated operation. Upon receiving the verification request, the one-call center (200) uses the operation location and the asset repository (202) to determine one or more assets in proximity to the operation location. Upon processing the verification request, the one-call center (200) sends: (i) a verification response to the operator (204) listing the one or more asset holders (206, 208, 210) associated with the one or more assets determined to be in proximity to the operation location; and (ii) a notification identifying the operator to each of the one or more asset holders (206, 208, 210) associated with the one or more assets determined to be in proximity to the operation location.

As such, the benefit resulting from the processing of a verification request by the one-call center (200) is the visibility realized between the operator (204) and the asset holders (206, 208, 210) retaining assets in proximity to the contemplated operation. The operator (204) is apprised of which, if any, asset holders (206, 208, 210) are likely to be affected when the operation is performed at the contemplated location. The asset holders (206, 208, 210), who are in the best position to apprise the operator (204) of exact asset locations, are apprised of a potentially damaging activity proximate to their held assets. Accordingly, this visibility allows for the possibility of adjusting the contemplated operation location to avoid compromising any proximate offshore assets as well as the operation itself. This visibility also allows for permit negotiations, when necessary, between the operator (204) and commercial asset holders (206, 208, 210) or possibly government entities.

In one or more embodiments of the invention, depth is a consideration in verifying an operation in a body of water. As such, asset holders (206, 208, 210) may specify an asset depth as part of the registration and update mechanisms with the one-call center (200). Accordingly, the one-call center (200) may maintain a depth (or set of depths) in association with each registered asset in the asset repository (202). Operators (204), requesting verification of contemplated operations, may likewise specify an operation depth, which the one-call center (200) takes into consideration during the verification mechanism.

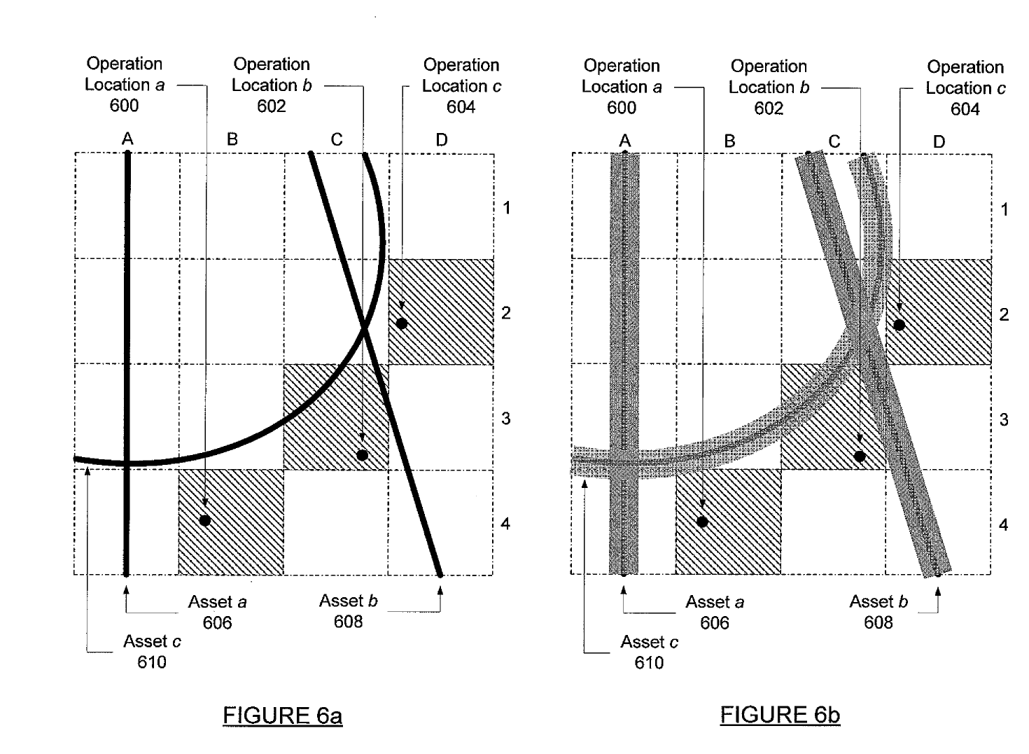

In one embodiment of the invention, each asset may further be associated with a buffer zone (see e.g., FIG. 6b). The buffer zone defines a region (two or three-dimensional region) surrounding the asset. The benefit of using a buffer zone is to create a margin of error. For example, for a particular asset, the asset holder may want to be notified of any operations (contemplated or currently being performed) within a certain number of feet (e.g., 200 feet) of the given asset. In such cases, the asset holder may define a buffer zone for the asset. The buffer zone for the asset may be set at a default value specified by the asset holder or the one-call center. Further, the buffer zone may be uniform or non-uniform.

The communication between the operator (204), the one-call center (200), and the asset holders (206, 208, 210) may be performed using any known electronic communication infrastructure and/or mechanism including, but not limited to, wireless networks, wired networks, satellite networks, e-mail, short message service (SMS) messages, or any combination thereof.

Because a one-call center is capable of registering assets located in various state, federal, or international water jurisdictions, it aggregates data that may otherwise be stored in a variety of distinct sources. For example, an operator in the Gulf of Mexico may be concerned about assets falling under a variety of jurisdictions: the state waters of Texas; the state waters of Louisiana; the state waters of Mississippi; the state waters of Alabama; the state waters of Florida; the Federal waters of the United States; the waters falling under the jurisdiction of Mexico; and international waters. Rather than having to contact many different state, federal, and international authorities to determine the assets registered with each of the distinct authorities pertinent to the Gulf of Mexico, a one-call center in accordance with embodiments of the invention provides the operator with a centralized verification and notification authority.

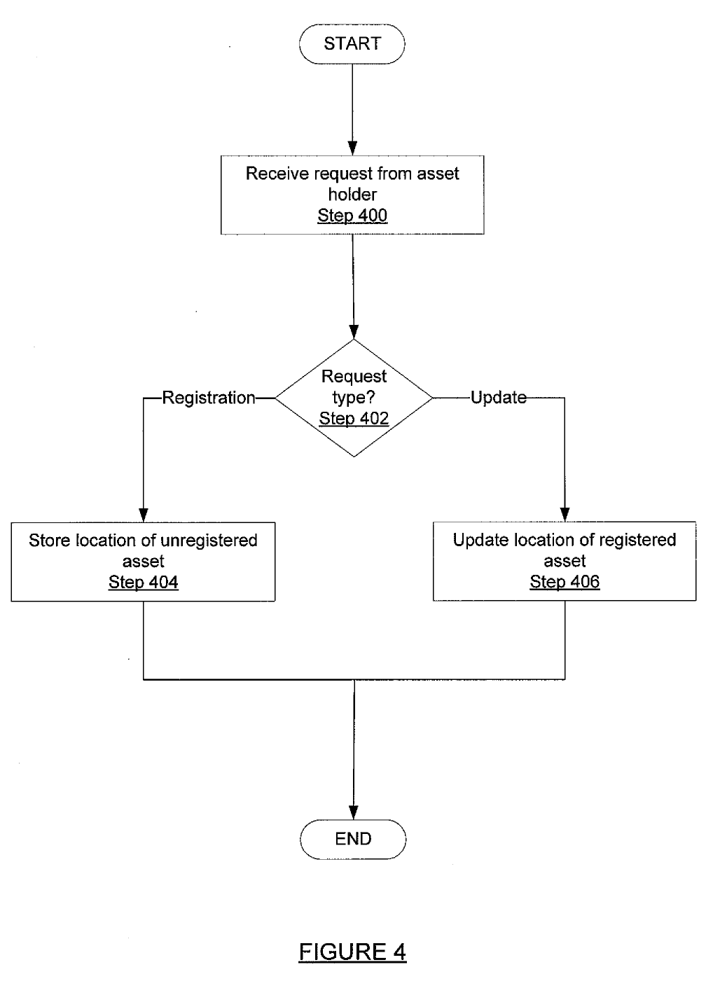

FIG. 3 shows data maintained in accordance with one or more embodiments of the invention. In one or more embodiments of the invention, the asset repository stores and maintains a registered asset in association with a mapped grid location. In one or more further embodiments of the invention, the asset repository may further store and maintains a depth measurement in association with each registered asset.

As such, FIG. 3 shows a concrete example of how these associations are maintained. For example, Asset a (306), Asset b (310), and Asset c (314) are shown to be maintained in association with Grid Location a (300). Further, each of the maintained assets (306, 310, 314) is further associated with a depth measurement (308, 312, and 316, respectively).

Referring to FIG. 1a, some assets are of a size significant enough to span many mapped grid locations. Accordingly, such assets are associated with more than one mapped grid location in the asset repository. Returning to FIG. 3, Asset a (306) is associated with both Grid Location a (300) and Grid Location b (302). Similarly, Asset c (314) is associated with both Grid Location a (300) and Grid Location b (302). In other instances, the asset may be entirely contained within a single mapped grid location and is therefore associated with one and only one mapped grid location. As shown in FIG. 3, Assets b, d, and e (310, 318, 322 respectively) are examples of assets associated with one and only one mapped grid location. Though not shown in FIG. 3, each asset may also be associated with a buffer zone (discussed above).

Those skilled in the art will appreciate that the data structure shown in FIG. 3 is only an example and not intended to limit the scope of the invention. Further, other data structures that are configured to maintain the aforementioned information may also be used.

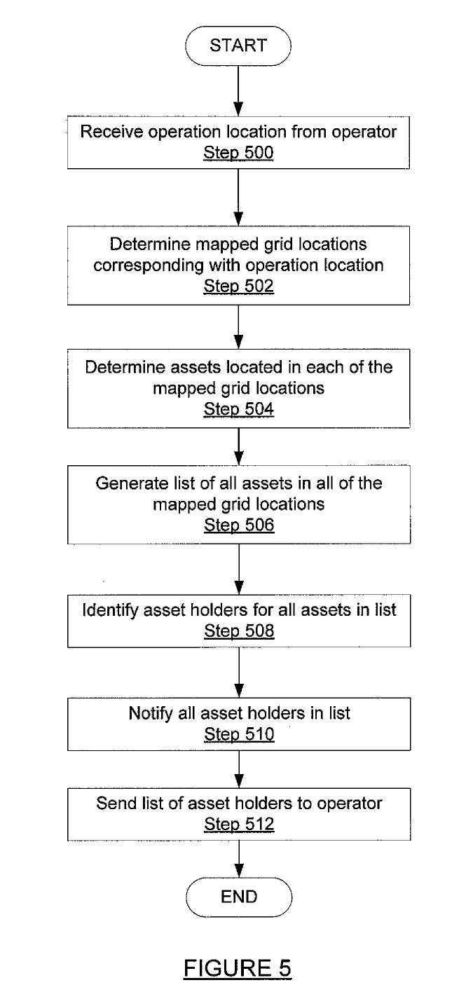

FIGS. 4 and 5 show flowcharts in accordance with one or more embodiments of the invention. While the various steps in the flowcharts shown in FIGS. 4 and 5 are presented and described sequentially, one of ordinary skill will appreciate that some or all of the steps may be executed in different orders, may be combined or omitted, and some or all of the steps may be executed in parallel.

The process shown in FIG. 4 may be used, for example, to obtain the location for an asset. More specifically, the process is directed to registering a new asset or updating the registration for a pre-registered asset.

In Step 400, a request is received from an asset holder. The request from the asset holder includes a location for the asset associated with the asset holder. In one or more embodiments of the invention, the request is not received directly from the asset holder but rather on behalf of the asset holder. In Step 402, a determination is made about whether the request is to register a new asset or to update the registration for a pre-registered asset. In the case of a new registration request, the asset location provided with the request is the location for the new asset. In the case of a registration update request, the asset location provided with the request is the new location for the pre-registered asset.

Regardless of which case described in Step 402 is operative, the asset location as originally provided with the request may necessarily require conversion, in Step 404 or Step 406, to a mapped grid location. In one or more embodiments of the invention, the asset location may be provided as one or more Global Positioning System (GPS) coordinates, as one or more pairs of latitude and longitude coordinates, or any other information sufficient to locate the asset. In each of those cases, a conversion to the mapped grid system used in one or more embodiments of the invention is necessary. In other cases, conversion may be unnecessary as the asset location may be provided as one or more mapped grid locations that correspond to the grid system in use. Subsequently, in Step 404 or Step 406, the asset is associated with the mapped grid location in the asset repository.

In one or more embodiments of the invention, an alternative format for mapping assets may be used as a base format for the storage and maintenance of asset locations. For example, in one or more embodiments of the invention, asset locations may be maintained with latitude and longitude coordinates instead of mapped grid units. In one or more other embodiments of the invention, asset locations may be maintained with GPS coordinates. Essentially, any format for mapping assets may be used as the base format so long as the format sufficiently describes the location of the asset. Accordingly, depending on the base format in use, operation locations and asset locations provided to the one-call center in formats other than the base format will require conversion to the base format for purposes of operation verification or asset registration.

In one or more embodiments of the invention, the process shown in FIG. 4 may likewise account for an asset depth. As such, the request received in Step 400 may include an asset depth in addition to an asset location. Further, the storage or update function, in Steps 404 and 406 respectively may associate the provided asset depth with the asset registration in the asset repository.

The process shown in FIG. 5 may be used, for example, to verify an operation in a body of water. In Step 500, an operation location for a contemplated operation is received. In one or more embodiments of the invention, the operation location is included in a verification request sent to the one-call center. In one or more further embodiments of the invention, the verification request is sent to the one-call center by the operator.

In Step 502, at least one of a plurality of mapped grid locations corresponding with the operation location is determined as a function of the operation location. In one or more embodiments of the invention, the operation location may require conversion to a mapped grid location from some other format. In one or more embodiments of the invention, the asset location may be provided in the format of one or more Global Positioning System (GPS) coordinates, as one or more pairs of latitude and longitude coordinates, or any other information sufficient to locate the asset.

In Step 504, registered assets are determined for each of the plurality of mapped grid locations corresponding with the operation location. In Step 506, a list is compiled of all the registered assets determined for the plurality of mapped grid locations corresponding with the operation location. In Step 508, asset holders are determined for each registered asset in the compiled list of Step 506. In Step 510, each of the asset holders determined in Step 508 is notified of the identity of the operator. In Step 512, the operator is sent a verification response including a list of all the asset holders determined in Step 508.

In one or more embodiments of the invention, the process shown in FIG. 5 may likewise account for an asset depth. As such, an operation depth may be received along with the operation location in Step 500. Further, the compilation of a list of assets in Step 506 may effectively use a criteria to filter out assets that do not have an associated asset depth proximate to the operation depth. An example of such a filter may be to only add assets to the list which have an asset depth within a specified range of the operation depth.

In one or more embodiments of the invention, the receipt of a verification request and the sending of a verification response are handled by a web service. Further, in one or more embodiments of the invention, the registration, update, and notification mechanisms are handled by a web service.

FIGS. 6a and 6b show similar two-dimensional views of assets residing in a body of water. In both 6a and 6b, Asset a (606), Asset b (608), and Asset c (610) are registered assets maintained in an asset repository in accordance with one or more embodiments of the invention. The figures further show three operation locations: Operation Location a (600), Operation Location b (602), and Operation Location c (604), obtained through the receipt of one or more verification requests by a one-call center.

Mapped grid locations are then determined in correspondence with an operation location if the operation location is, at least partially, located in the mapped grid location. Under that guideline, Operation Location a (600) corresponds with row 4 column B, Operation Location b (602) corresponds with row 3 column C, and Operation Location c (604) corresponds with row 2 column D.

Having determined mapped grid locations in correspondence with operation locations, the corresponding mapped grid locations are then used to determine which, if any, registered assets are associated with those corresponding mapped grid locations. In one or more embodiments of the invention, an asset is associated with a mapped grid location if the asset is, at least partially, located in the mapped grid location. As such, Table 2 shows how the assets of FIG. 6a are associated with mapped grid locations and maintained by an asset repository in one or more embodiments of the invention.

TABLE 2
Assets Associated by Grid Location as shown in FIG. 6a

| Grid Locations | Associated Assets |
|---|---|
| Row 1 Column A | Asset a |
| Row 1 Column B | None |
| Row 1 Column C | Asset b, Asset c |
| Row 1 Column D | None |
| Row 2 Column A | Asset a |
| Row 2 Column B | None |
| Row 2 Column C | Asset b, Asset c |
| Row 2 Column D | None |
| Row 3 Column A | Asset a, Asset c |
| Row 3 Column B | Asset c |
| Row 3 Column C | Asset b, Asset c |
| Row 3 Column D | Asset b |
| Row 4 Column A | Asset a |
| Row 4 Column B | None |
| Row 4 Column C | None |
| Row 4 Column D | Asset b |

In view of the information displayed in Table 2, no registered assets are located in the mapped grid location for row 4 column B, where Operation Location a (600) is located. Asset b (608) and Asset c (610) are both located in the mapped grid location for row 3 column C, where Operation Location b (602) is located. No registered assets are located in the mapped grid location for row 2 column D, where Operation Location c (604) is located. Consequently, in verifying the operation locations (600, 602, 604) shown in FIG. 6a, only Operation Location b (602) requires performance of the notification function by the one-call center due to the proximity of registered assets to the operation location.

In performing the notification function, the one-call center determines asset holders for Asset b (608) and Asset c (610), respectively. For purposes of this example, Asset b (608) is associated with Asset Holder b and Asset c (610) is associated with Asset Holder c. As such, Asset Holder b and Asset Holder c are both sent a notification message by the one-call center specifying, at least, the identity of the operator. In one or more embodiments of the invention, the notification message will further include Operation Location b (602). In one or more embodiments of the invention, the notification message will further include contact information for the operator.

The one-call center further sends a verification response to the operator specifying, at least, the identity of the asset holders. In this example, the operator would receive a verification response apprising them of the fact that Asset Holder b and Asset Holder c retain assets in proximity to Operation Location b (602) as specified by in the verification request.

In providing the described notification function to the operator associated with Operation Location b (602), Asset Holder b, and Asset Holder c, the one-call center has minimized the potential for disaster were the contemplated operation to be performed as planned in mapped grid location for row 3 column C. Having receiving the notification message, the asset holders may subsequently directly contact and apprise the operator of the exact whereabouts of the registered assets located in that mapped grid location in proximity to the contemplated operation location. Having received the verification response, the operator is apprised of the strong possibility that in-place assets in proximity with the contemplated operation location are jeopardized and, as such, may halt or adjust operation until the circumstances pertaining to the operation location are fully realized.

FIG. 6b shows the same set of assets and operation locations as described above with regards to FIG. 6a where each of the assets is associated with a buffer zone. In using the buffer zone, an asset is associated with a mapped grid location if the asset or a buffer zone associated with the asset is, at least partially, located in the mapped grid location. As such, the buffer zone determination, evidenced in FIG. 6b by the shaded region effectively tracing over each of the three assets, associates a broader region with each registered asset.

TABLE 3
Assets Associated by Grid Location as shown in FIG. 6b

| Grid Locations | Associated Assets |
|---|---|
| Row 1 Column A | Asset a |
| Row 1 Column B | None |
| Row 1 Column C | Asset b, Asset c |
| Row 1 Column D | Asset c |
| Row 2 Column A | Asset a |
| Row 2 Column B | None |
| Row 2 Column C | Asset b, Asset c |
| Row 2 Column D | Asset c, Asset b |
| Row 3 Column A | Asset a, Asset c |
| Row 3 Column B | Asset c |
| Row 3 Column C | Asset b, Asset c |
| Row 3 Column D | Asset b |
| Row 4 Column A | Asset a, Asset c |
| Row 4 Column B | Asset c |
| Row 4 Column C | None |
| Row 4 Column D | Asset b |

As shown in Table 3 the buffer zone determination affords some assets a broader spatial association with respect to mapped grid locations. For example, the buffer zone determination allows for newly-found associations of both Asset b and Asset c with the mapped grid location for row 2 column D. In another example, Asset c is further newly-associated with mapped grid locations for row 1 column D, row 4 column A, and row 4 column B by virtue of the buffer zone determination.

In view of the information displayed in Table 3, the verification of Operation Location a (600), Operation Location b (602), and Operation Location c (604) is different from that described with relation to FIG. 6a. Due to the broader spatial associations between the in-place assets and the mapped grid locations, both Operation Location a (600) and Operation Location c (604) require the one-call center to perform notification functions in this context. In contrast, associations between registered assets and mapped grid locations made without use of a buffer zone determination, as discussed above in relation to FIG. 6a, required no such performance of a notification function with regards to those operation locations.

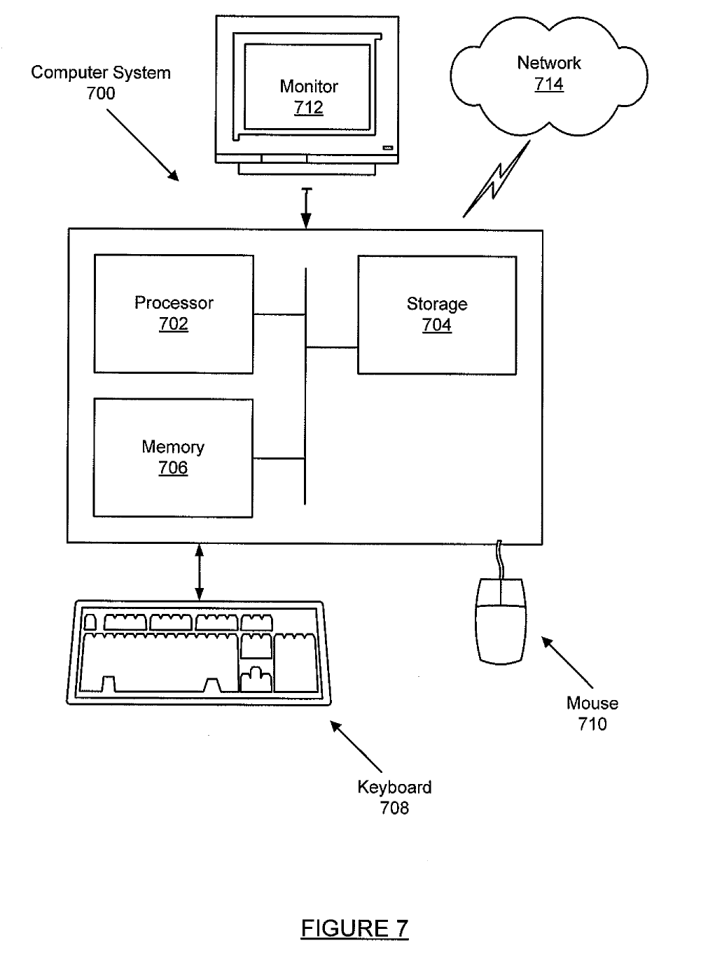

Embodiments of the invention may be implemented on virtually any type of computer regardless of the platform being used. For example, as shown in FIG. 7, a computer system (700) includes one or more processors (702), associated memory (706) (e.g., random access memory (RAM), cache memory, flash memory, etc.), a storage device (704) (e.g., a hard disk, an optical drive such as a compact disk drive or digital video disk (DVD) drive, a flash memory stick, etc.), and numerous other elements and functionalities typical of today's computers (not shown). The computer (700) may also include input means, such as a keyboard (708), a mouse (710), or a microphone (not shown). Further, the computer (700) may include output means, such as a monitor (712) (e.g., a liquid crystal display (LCD), a plasma display, or cathode ray tube (CRT) monitor). The computer system (700) may be connected to a network (714) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (700) includes at least the minimal processing, input, and/or output means necessary to practice embodiments of the invention.

Further, those skilled in the art will appreciate that one or more elements of the aforementioned computer system (700) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable medium comprising executable instructions for the verification of an operation in a body of water, wherein executable instructions comprise instructions to:
receive a verification request comprising an operation location for an operation;
determine at least one of a plurality of mapped grid locations corresponding with the operation location;
determine, using an asset repository, a first asset associated with at least one of the plurality of mapped grid locations;
determine an asset holder for the first asset;
send, to the asset holder, a notification comprising the identity of the operator; and
send, to the operator as a verification response, the identity of the asset holder,
wherein the plurality of grids are defined by a Minerals Management Service (MMS).

2. The computer readable medium of claim 1, comprising further executable instructions to:
receive a registration request comprising an asset location for a second asset, wherein the second asset is not registered with the asset repository;
determine at least one of the plurality of mapped grid locations corresponding with the asset location for the second asset; and
register the second asset in the asset repository, using the at least one of the plurality of mapped grid locations corresponding with the asset location.

3. The computer readable medium of claim 2, comprising further executable instructions to:
receive an update request comprising a new location for the second asset, wherein the second asset is registered with the asset repository;
determine at least one of the plurality of mapped grid locations corresponding with the new location for the second asset; and
update the second asset in the asset repository to be associated with the at least one of the plurality of mapped grid locations corresponding with the new location.

4. The computer readable medium of claim 1, wherein the plurality of mapped grid locations comprise locations in state water jurisdiction and locations in federal water jurisdiction.

5. The computer readable medium of claim 1, wherein the operation location comprises a Global Positioning System (GPS) coordinate.

6. The computer readable medium of claim 1, wherein the operation location comprises a latitude coordinate and a longitude coordinate.

7. The computer readable medium of claim 1, wherein the asset repository further associates a protected area with at least one of the plurality of mapped grid locations.

8. The computer readable medium of claim 1, wherein the asset repository further associates a restricted area with at least one of the plurality of mapped grid locations.

9. The computer readable medium of claim 1, wherein the notification sent to the asset holder is transmitted across a network.

10. The computer readable medium of claim 1, wherein executable instructions to determine that the first asset is associated with the at least one of the plurality of mapped grid locations comprise executable instructions to:
determine that a buffer zone associated with the first asset is associated with the at least one of the plurality of mapped grid locations.

11. A computer readable medium comprising executable instructions for the verification of an operation in a body of water, wherein executable instructions comprise instructions to:
receive a verification request comprising an operation location and an operation depth for an operation;
determine at least one of a plurality of mapped grid locations corresponding with the operation location;
determine, using an asset repository, a first asset associated with at least one of the plurality of mapped grid locations, wherein the asset depth of the first asset is within a defined range of the operation depth;
determine an asset holder for the first asset;
send, to the asset holder, a notification comprising the identity of the operator; and
send, to the operator as a verification response, the identity of the asset holder,
wherein the plurality of grids are defined by a Minerals Management Service (MMS).

12. The computer readable medium of claim 11, comprising further executable instructions to:
receive a registration request comprising an asset location and an asset depth for a second asset, wherein the second asset is not registered with the asset repository;
determine at least one of the plurality of mapped grid locations corresponding with the asset location for the second asset; and
register the second asset in the asset repository using the at least one of the plurality of mapped grid locations corresponding with the asset location and when the asset depth is associated with the second asset.

13. The computer readable medium of claim 12, comprising further executable instructions to:
receive an update request comprising a new asset depth for the second asset, wherein the second asset is registered with the asset repository; and
update the second asset in the asset repository to be associated with the new asset depth.

14. The computer readable medium of claim 11, wherein the plurality of mapped grid locations comprise locations in state water jurisdiction and locations in federal water jurisdiction.

15. The computer readable medium of claim 11, wherein the operation location comprises a GPS coordinate.

16. The computer readable medium of claim 11, wherein the operation location comprises a latitude coordinate and a longitude coordinate.

17. The computer readable medium of claim 11, wherein the asset repository further associates a protected area with at least one of the plurality of mapped grid locations and at least one asset depth for the protected area.

18. The computer readable medium of claim 11, wherein the asset repository further associates a restricted area with at least one of the plurality of mapped grid locations and at least one asset depth for the restricted area.

19. The computer readable medium of claim 11, wherein the notification sent to the asset holder is transmitted across a network.

20. The computer readable medium of claim 11, wherein executable instructions to determine that the first asset is associated with the at least one of the plurality of mapped grid locations comprise executable instructions to:
determine that a buffer zone associated with the first asset is associated with the at least one of the plurality of mapped grid locations.
